(19) United States
(12) Patent Application Publication
(10) Pub. No.: US 2012/0148753 A1
(43) Pub. Date: Jun. 14, 2012

(54) PREPREG

(76) Inventors: Masanori Kubota, Hockessin, DE (US); Ayako Kubota, Hockessin, DE (US); Munetaka Kubota, Hockessin, DE (US); Alexander Kubota, Hockessin, DE (US)

(21) Appl. No.: 12/026,118

(22) Filed: Feb. 5, 2008

Related U.S. Application Data
(60) Provisional application No. 61/012,975, filed on Dec. 12, 2007.

(51) Int. Cl. B05D 3/02; D02G 3/36; C09D 179/08; C09D 177/00; C09D 175/04; B32B 27/02; C09D 123/12

(52) U.S. Cl. 427/375; 428/375; 428/372; 524/528; 524/538; 524/500; 524/539

(57) ABSTRACT

The present invention relates to a prepreg composite and to a process for manufacturing the prepreg composite. The manufacturing process involves surface treatment and impregnation of a high tenacity fibrous material with a surface treatment agent and a polymer matrix resin material. The fiber may be in the form of a woven, unidirectional or non-woven fabric. The fiber may optionally be coated with a surfactant and/or an adhesion promoter. Prior to treatment, the surface treatment materials may be contained in a dispersion of nano-particles in which each material has a film forming process temperature at a value below the degradation temperature of the fiber. The layers may be applied individually or simultaneously onto the fibers. The coated material is heat dried without compression to form a prepreg composite.

### CROSS REFERENCE TO RELATED APPLICATION

The present application claims the benefit of U.S. Provisional Application Ser. No. 61/012,975, filed Dec. 12, 2007, the disclosure of which is expressly incorporated herein by reference in its entirety.

### FIELD OF THE INVENTION

The present invention relates to a prepreg composite and to a process for manufacturing the prepreg composite. The manufacturing process involves impregnation of a high tenacity fibrous material with a surface treatment agent and a polymer matrix resin material.

### BACKGROUND OF THE INVENTION

Polymer matrix composite parts are widely used in the transportation industry, including the manufacture of automobiles and aircraft. Polymer matrix composite parts are often manufactured by consolidation of pre-impregnated (prepreg) composite materials. Prepreg composite materials may be made by coating a high tenacity fibrous material with a polymer matrix resin. The fibrous material is usually a carbon, glass or organic fiber filament. The filaments may be gathered into bundles to produce fibers that can subsequently be processed into woven fabric, unidirectional continuous tape or non-woven matt fabric materials. Non-woven fabric materials may use either chopped (i.e. short) or long fibers. During filament manufacture, filament processing and the subsequent production of woven or non-woven fabric, the fibers are often treated with a lubricant to ensure that the fibers can be mechanically handled in producing the fabric.

Prepreg composite materials can be manufactured in unidirectional, woven or non-woven forms by coating the appropriate fibers or fabric with a polymer matrix resin. The polymer matrix resin can be a thermoset or thermoplastic polymer. In order to produce a high quality prepreg, the polymer matrix resin must intimately bond to the surface of the fiber. The intimate bonding of the fibers and polymer matrix resin is greatly enhanced by processing the fiber surface before coating the fiber with the matrix resin. This processing usually includes several steps. First, the residual lubricant or machine oil left on the fibers from the fiber manufacturing and fabric production processes must be washed off and removed. Second, the fibers are treated with a surface treatment agent to enhance the intimate chemical and physical bonding of the fiber surface and polymer matrix resin on the molecular scale. Lastly, the polymer matrix resin is applied to the fiber forming a prepreg composite.

The three-step process of cleaning, applying a surface treatment agent and applying a polymer matrix resin to the fibers is time consuming and labor intensive. Also, effective surface treatment agent treatments have been limited to use with carbon fibers and thermoset matrix resin systems. Surface treatment agent treatments have not been developed or optimized for other prepreg systems, such as glass or organic fibers combined with thermoset or thermoplastic matrix resins. The present invention is directed to prepreg composites comprising a surface treatment agent and a polymer matrix resin. The present invention is also directed to a manufacturing process that cleans the reinforcement fibers, applies a surface treatment agent treatment onto the reinforcement fibers and coats a polymer matrix resin onto the reinforcement fibers to produce a high quality prepreg composite.

### SUMMARY OF THE INVENTION

The invention is directed to a prepreg composite comprising a high tenacity fiber having a surface treatment agent and polymer matrix resin coated on the surface of the fiber.

The invention is also directed to a method of manufacturing the prepreg composite comprising coating a high tenacity fiber with a surface treatment agent and a polymer matrix resin. The method may also comprise cleaning the fiber with a surfactant, coating the fiber with an adhesion promoter, or both. The surface treatment agent may be in the form of a nano-particle dispersion that can intimately bond to the fibers. The polymer matrix resin may be in the form of a micrometer diameter powder in a slurry that can intimately bond to the surface treatment agent coating on the fiber. The polymer type of surface treatment agent is preferably selected for optimum compatibility and bonding with the polymer type of the matrix resin.

The materials may be coated sequentially or simultaneously. In sequential coating application, the surfactant, surface treatment agent and adhesion promoter are preferably applied first, followed by the polymer matrix resin. In simultaneous coating application, the surfactant, surface treatment agent, adhesion promoter and polymer matrix resin are preferably in a single solution that is coated onto the high tenacity fiber material to manufacture a prepreg composite.

The invention also teaches that the composite prepreg is preferably heated to a temperature that melts the surface treatment and the polymer matrix resin coatings so that they adhere to the fiber. The heating of the prepreg may be at a temperature that will decompose the surfactant used in coating the fibers. Preferably, the melt temperature for the polymers is greater than the decomposition temperature of the surfactant used in coating the fiber and the heat is sufficient to decompose the surfactant. The melt temperature for the polymers used to coat the reinforcement fiber is preferably less than the decomposition temperature of the fiber.

Finally, the invention is directed to a dispersion comprising a surface treatment agent and a polymer matrix resin. The dispersion may also comprise a surfactant, an adhesion promoter, or both.

### BRIEF DESCRIPTION OF THE DRAWING

This invention is best understood from the following detailed description when read in connection with the accompanying drawing.

FIG. 1 is a cross section diagram of a fiber coated with media layers.

### DETAILED DESCRIPTION OF THE INVENTION

The manufacture of a high tenacity fibrous prepreg material that can be used to fabricate composite articles of variable thicknesses and dimensions is provided. The composite articles can be used in manufacture of a broad variety of industry products including: automobile and aircraft body panels and components, highway and road signs, equipment housing compartments, boat hulls, security barriers, architectural panels, building materials, transport and cargo containers, fuel tanks, compressed gas tanks, hazardous material containers, military structures and equipment, and housings for a variety of consumer and industrial products where impact resistance and container strength are desired.

The manufacture of prepreg composites is provided. The manufacture comprises surface treating a high tenacity fibrous material using a surface treatment agent and a polymer matrix resin. The process may also comprise surface treating the fiberous material with a high productivity cleaner, an adhesion promoter, or both. The process may involve multiple steps or occur in a single-step. Generally, the cleaning, surface treatment and adhesion promotion is preferably done by applying a first coating on the material using a coating solution that comprises a nano-particle size polymer dispersion surface treatment agent and, optionally, a surfactant, an adhesion promoter, or both. A second coating onto the material is preferably done by applying polymer matrix resin slurry. An alternative process may be done by applying a single coating onto the high tenacity fibrous material. A single coating solution preferably comprises a surface treatment agent, a polymer matrix resin, optionally, a surfactant, an adhesion promoter, or both. Preferably, the slurry is simultaneously coated onto the high tenacity fibrous material to produce a composite prepreg.

After coating, the composite prepreg is preferably heated to a processing temperature that melts the surface treatment agent and polymer matrix resin coatings so that the polymer particles melt, flow onto, and/or adhere to the fibrous material. The melt temperature for the polymers may be greater than the decomposition temperature of the surfactant used in coating the fiber and the heat may be sufficient to decompose the surfactant during the melting process. The melt temperature for the polymers is preferably less than the degradation temperature of the reinforcement fiber.

As used herein, the following terms are defined:

“Composite” means any combination of two or more materials (such as fiber reinforcing elements and a composite matrix binder) differing in form or composition on a macro scale. The constituents retain their identities: that is, they do not dissolve or merge completely into one another although they act in concert. Normally, the components can be physically identified and interface between one another.

“Fabric” means a cloth that can be, for example, non-woven, needled, woven, knit, or braided fibrous material, such as yarn, tow, roving, or individual fibers.

“Fiber” means a fundamental component used in the assembly of yarns and fabrics. Generally, a fiber is a component that has a length dimension which is much greater than its diameter or width. This term includes ribbon, strip, staple, and other forms of chopped, cut or discontinuous fiber and the like having a regular or irregular cross section. “Fiber” also includes a plurality of any one of the above or a combination of the above.

“High tenacity fiber” means that class of synthetic, glass or natural non-glass fibers having high values of tenacity greater than 10 g/denier, such that they lend themselves for applications where high abrasion and/or cut resistance is important. Typically, high tenacity fibers have a very high degree of molecular orientation and crystallinity in the final fiber structure. High tenacity fibers are preferably made from bundled filaments that are individually quite small, having a diameter of micrometers. A bundle of hundreds to thousands of filaments may be wound together to manufacture a single fiber. A single fiber may be combined with multiple fibers to make a unidirectional, woven or non-woven fabric.

“Surface treatment agent” means a chemical entity that when applied to a surface, such as the surface of the high tenacity fiber, modifies the fiber surface to make the fiber surface more amenable to physical, mechanical or chemical bonding to a polymer matrix resin coating.

“Processing temperature” means a temperature or temperature range at which a polymer emulsion or polymer slurry coating dries, softens, melts and forms a film on the fiber surface and adheres to the fiber surface.

“Melt temperature” means a temperature at which a polymer softens and changes from a solid particle into a liquid state that can flow.

“Degradation temperature” refers to the temperature limit at which a polymer begins to break down and degrade into polymer molecular chain sub-components.

“Decomposition temperature” refers to the temperature limit at which a polymer or a chemical entity breaks down and decomposes into molecular sub-components such as gases and carbonized solids.

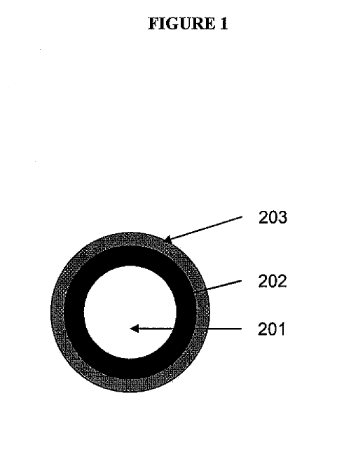

FIG. 1 shows a cross section diagram of a single fiber showing bonding to the fiber surface (201) of a surface treatment agent and a polymer matrix resin. The first coating (202) preferably is a nano-scale dispersion of a surface treatment agent, optionally including a surfactant, an adhesion promoter or both. The first coating treats the fiber surface so that it will intimately bond to the second coating (203) that preferably is a micrometer-scale polymer matrix resin (i.e. thermoplastic polymer matrix) in aqueous slurry. The coatings may be applied sequentially as separate coating solutions or simultaneously as a single coating solution.

After coating, the composition may be heated to a processing temperature that melts the surface treatment agent and polymer matrix resin coatings so that they adhere to the fiber. Preferably, the melt temperature for the polymers may be greater than the decomposition temperature of the surfactant used in coating the fiber and the heat is sufficient to decompose the surfactant during the melting process. The melt temperature for the polymers is preferably less than the degradation temperature of the reinforcement fiber.

A suitable fiber for the production of the reinforcement fabric used in the prepreg can be any high tenacity fiber commonly used as fiber reinforcement in the manufacture of prepregs and composites. A high tenacity inorganic fiber may be selected from the group consisting of carbon, glass or silicone carbide. (See U.S. Patent Application No. 2004/0241415 and U.S. Pat. No. 6,984,445, both of which are hereby incorporated by reference in their entirety). A high tenacity organic fiber may be selected from the group consisting of polyarylate, poly-p-benzamide, poly-paraphenylene terephthalamide, poly-(p-phenylene-2,6-benzobisoxazole), meta-linked aromatic polyamide and high density polyethylene fibers.

Fibers are typically manufactured from filaments that are bundled into fiber bundles. The number of filaments in a fiber bundle varies depending on the strength and stiffness requirements of the fiber application. The diameter of the filament used in making a high tenacity fiber is typically in the range of about 1 to about 50 micrometers, preferably in the range of about 5 to about 30 micrometers. The fibers can be combined in the form of a fabric. Typically, fibers are surface treated with lubricant material, such as machine oil, that acts as a slip agent during the mechanical manufacturing process to produce woven or non-woven fabric. Manufacturing a prepreg is normally done in a three-step process. First, the fiber/fabric is washed to remove any residual lubricant material (e.g, machine oil) on the fibers. Then, the fiber/fabric is coated with a sizing chemistry (surface treatment agent) to treat the raw fiber surface so that the surface is compatible with the polymer matrix resin. Lastly, the fabric is coated with a polymer matrix resin and dried to form the prepreg composite.

The fibers of the present invention may be used in various forms and applications. Continuous fibers can be woven into a fabric or incorporated into unidirectional continuous fiber tape. The fibers preferably treated with a surface treatment agent and then coated with polymer matrix resin to form a fabric or tape prepreg composite. The fibers can be cut into non-continuous fibers and incorporated into a non-woven fabric such as a matt fabric. The non-woven fabric may then be treated with a surface treatment agent and then coated with a polymer matrix resin to form a matt prepreg. Cut fibers can be needle-punched into a non-woven randomly placed fabric. This fabric may then be treated with a surface treatment agent and then coated with a polymer matrix resin to form a non-woven low bulk density prepreg composite. Chopped fibers, of uniform or random length, can be treated with a surface treatment agent and randomly dispersed into polymer matrix resin during an extrusion process. The extruded reinforced polymer can be cut into pellets that are subsequently used in injection or compression molding to prepare fiber-reinforced parts.

In the prepreg manufacturing processes mentioned above, the fibers are preferably first washed and surface treated with a surface treatment agent to optimize the surface contact or wetting of the fiber before the polymer resin is applied. The polymer matrix resin typically is not chemically compatible with and will not readily wet the surface of the raw fiber without the pretreatment. Prepregs made with non-treated fiber will tend to have a weakly bonded fiber to polymer matrix resin interface and produce prepreg and final composite materials that have non-uniform and lower performance mechanical and physical properties.

In the present invention, the fibers are coated with a surface treatment agent preferably in the form of a nano-particle resin dispersed in an aqueous or non-aqueous dispersion. The nano-particle resin dispersion particle size is preferably less than about 1 micrometer in diameter, preferably less than about 0.5 micrometers and more preferably less than about 0.1 micrometers. The particle size diameter of the surface treatment agent is preferably chosen to be equal to or less than ⅕th of the diameter of the filaments used to make up the fibers in the fabric so that the nano-particle dispersion can easily migrate into and between the micron-scale diameter fibers and coat the fibers in the fabric.

The nano-particle dispersion is preferably made from a polymer resin dispersed in water for application and adherence to a fiber or fabric. Suitable polymer resins for application and adherence to the fiber or fabric may be any surface treatment agent known in the industry or commonly used in the manufacture of prepregs and composites. Suitable polymer resins that can be used as a surface treatment agent may be one or a blend of the following polymers: a polyamide/epoxidized styrene-butadiene block copolymer, ethylene glycidyl methacrylate copolymer, co-polypropylene, co-polyester, epoxy, polymethacrylate iso-butylester, polymethacrylic n-butylester, butyl methacrylate-styrene, copolymer, polymethylmethacrylate, polyamide, co-polyamide, polyvinyl acetate, polyvinyl alcohol, polyethylene, polyurethane, thermoplastic polyether polyurethane, polyester, silyl resins, silyl-dimethacrylate, siloxane bond resins and silane coupling agents.

The polymer used in as a surface treatment agent is preferably selected for optimum compatibility and bonding to the polymer in the polymer matrix resin. Table 1 included in the Examples section of this document provides a list of surface treatment agent polymers and their respective compatibility with polymers in selected polymer matrix resins.

The surface treatment agent coating may also include a surfactant. The surfactant may be applied separately or it may be incorporated in the surface treatment agent dispersion and applied simultaneously with the surface treatment. The surfactant enhances the wetting of the fibers or fabric and helps disperse and remove any residual lubricant or machine oil on the fiber. This reduces the need to wash the fabric in a separate step during the treatment. Suitable surfactants include ionic, nonionic, and amphoteric surfactants known in the art. (See U.S. Patent Application. No. 2004/0197565 and U.S. Pat. No. 6,515,045, both of which are hereby incorporated by reference in their entirety).

An adhesion promoter may be applied to the fiber surface. The adhesion promoter may be applied separately or it may be incorporated in the surface treatment agent dispersion and applied simultaneously with the surface treatment. The adhesion promoter is a compound that promotes adhesion, such as silane coupling agents and silyl resins. The adhesion promoter may be any known adhesion promoter used in the industry to prepare prepreg and composites. The adhesion promoter may be selected from the group consisting of DOW CORNING A-1100, DOW CORNING Z6020, DOW CORNING 26040, epoxysilanes, aminosilanes, ureidosilanes, mercaptosilanes, silicon tetrachloride, alkoxy silanes (See U.S. Pat. Nos. 3,244,664, 3,692,874, 4,076,915, 5,075,377, 5,272,214 and 5,681,895), polyepoxides, polyisocyanates, polyimines, polyaldehydes, polyketones, polyanhydrides, polyesters, polyhalides (See U.S. Pat. No. 3,281,383), diesters (See U.S. Pat. No. 3,594,452), methoxy silanes (See U.S. Pat. No. 3,880,954), divinyl benzene (See U.S. Pat. No. 3,985,830), 1,3,5-benzene tricarboxylic acid trichloride (See U.S. Pat. No. 4,104,332), glycidoxytrimethoxy silanes (See U.S. Pat. No. 4,185,042) and oxydipropylbis(trimethoxy silane (See U.S. Pat. No. 4,379,891), all of which are hereby incorporated by reference in their entirety.

The surface treatment agent dispersion with optional surfactant, adhesion promoter or both, is preferably coated onto the high tenacity fabric. The coating can be done by known industry methods for coating a solution such as spraying, dipping, coating by knife coating, gravure and other mechanical coating methods. A preferred coating method is dip coating. The coated fabric is preferably dried using common drying procedures such as hot air convection drying or infrared heater drying. The fabric is initially dried to remove the dispersion solution carrier such as water. The coated fabric is than further heated to a process temperature where the surface treatment agent melts and forms a film that bonds to the fiber surface (202) as shown schematically in FIG. 1. In a preferred embodiment, the surface treatment agent dispersion coating may be applied onto the reinforced fiber that dries and melts to form a coating on the fiber surface. The surface treatment agent coating is applied onto the reinforced fiber at a concentration such that the surface treatment agent is preferably about 1 to about 20% by volume of the prepreg formed and more preferably about 5 to about 10% by volume of the prepreg formed.

The processing temperature to melt the surface treatment agent may be greater than the decomposition temperature of any residual surfactant or additive that might be present in the drying process. Additives, such as emulsifiers and foaming agents, may be added to the dispersions to enhance performance. It is preferred that any residual surfactant or additive decompose during the heating and melting of either the surface treatment agent polymer or polymer matrix resin. Residual surfactant or additive is not desirable in the prepreg or final composite composition because the residual surfactant or additive may act as a hydrophilic chemical and accelerate the absorption of water by the prepreg or composite. Preferably, the prepreg or final composite composition is substantially free of any residual surfactant or additive.

Decomposition of the residual surfactant or additive removes potential water absorption sites in the composition and minimizes prepreg or composite water absorption. For example, amine oxide surfactants and azodicarbonamide (ABFA) are two surfactants commonly used in producing nano-particle polymer dispersions. Amine oxide surfactants typically decompose at a temperature of less than about 200° C. Azodicarbonamide (ABFA) surfactant has a decomposition temperature between about 204° C. and about 213° C. The heat processing step to melt the nano-particle resin in the surface treatment agent and to melt the polymer matrix resin is preferably done at a temperature that is about 50° C. to about 100° C. greater than the melt temperature of the nano-particle resin or polymeric matrix resin material. This temperature is typically above 200° C. and preferably above 220° C. and most surfactants and additives present will decompose during the heat processing of the surface treatment agent. Moreover, the processing temperature to melt the surface treatment agent is preferably less than the decomposition temperature of the fiber/fabric.

A second coating may be applied to coat a polymer matrix resin onto the fibers. The polymer matrix resin layer may comprise any matrix resin known in the industry or commonly used in the manufacture of prepregs and composites. The polymer matrix resin may be a thermoplastic polymer layer formed from a material selected from the group consisting of polyethylene, polypropylene, polyethylene terephthalate, polyamide, polyurethane, polyethylmethacrylate, polymethylmethacrylate, polycarbonate, polystyrene, polyetherketone (PEK, PEKK, PEEK), polyether sulfone, polyphenylene sulfide, polyester amide, polystyrene, polyetherimide and polyimide.

The polymer matrix resin coating may be applied to the surface treated fibers from a micron-scale dispersion of the polymer matrix resin powder in aqueous or non-aqueous slurry. This thermoplastic powder may have a median particle size that is less than about 200 micrometers, preferably less than about 50 micrometer, and more preferably less than about 30 micrometers in diameter. A dispersion prepared with a polymer matrix powder that is less than 30 microns diameter will typically exhibit uniform flow onto the fibers in coating a fabric. A dispersion prepared with a polymer matrix powder that is greater than about 30 to about 50 micrometers in diameter will still effectively coat a fabric, however, it will typically exhibit less uniform flow. A larger particle size dispersion may not flow as smoothly and may appear bulky or clumpy. Therefore, industrial manufacturing processes may prefer the smaller particle size dispersions which flow better and may coat fabrics in a shorter time, under conditions using less agitation or lower temperatures, or combinations thereof.

The thermoplastic powder can be dispersed in an aqueous solution and applied as a second coating. The fiber/fabric may be treated with the dispersion slurry by using known manufacturing processes, such as spraying or dip coating. In a preferred embodiment, the polymer matrix resin dispersion coating may be applied onto the reinforced fiber that dries and melts to form a coating on the fiber surface. The amount of matrix resin applied to the fiber/fabric is preferably an amount sufficient to fill the fabric voids during subsequent hot press consolidation (thermoforming) processing of the prepreg into a composite. Thus, the volume ratio of the resin matrix applied to the fiber/fabric is preferably greater than about 20% by volume and more preferably greater than about 50% by volume of resin in the composite prepreg structure.

The polymer matrix resin coating on the fabric is preferably dried at a temperature to remove water and than the coated fabric is preferably heated above the melt temperature of the polymer matrix resin and melted onto the fabric to form a prepreg material. Preferably, the polymer matrix resin may have a processing temperature for drying and melting onto the fiber/fabric that is greater than the decomposition temperature of the surfactant present in the dispersion so that the surfactant decomposes during the heating and melting process. Preferably, the polymer matrix resin has a processing temperature for drying and melting onto the fiber/fabric that is less than the degradation temperature of the fiber.

The drying conditions used in preparing the prepreg composite of the present invention can be graduated. For example, an initial drying stage may be used at a temperature below the melt point of any resin used and also below the boiling point of any liquid form material used in the coating solution(s). Liquid form materials that may be present include, but is not limited to, water and volatile organic compounds. A drying temperature between about 60° C. and about 80° C. is preferred to remove moisture (e.g. water) and volatile organic compounds.

A second drying stage may be used at a temperature above the glass transition temperature (Tg) of the nano-particle resin or polymeric material in the dispersion. A drying temperature between about 90° C. and about 160° C. is preferred. A third drying stage may be used at a temperature about 50° C. to about 100° C. above the melt temperature of the nano-particle resin or polymer material in the dispersion.

In a preferred embodiment, the third drying stage conditions for a PA-200 co-polyamide dispersion containing co-polyamide nano-particles is about 230° C. The PA-200 co-polyamide particles have a melt point temperature between about 145° C. and about 150° C.

In another preferred embodiment, the third drying stage conditions for a PA-200 co-polyamide and polyamide 6 dispersion containing 700 nanometer particles of co-polyamide and 20 micrometer particles of polyamide 6 is about 260° C. The PA-200 co-polyamide particles have a melt point temperature between about 145° C. and about 150° C. The polyamide 6 particles have a melt point temperature of about 260° C.

In another preferred embodiment, the third drying stage conditions for UA-310 thermoplastic polyurethane dispersion containing thermoplastic polyurethane nano-particles is about 230° C. The US-310 thermoplastic polyurethane nano-particles have a melt point temperature of between about 150° C. and about 160° C.

The surface treatment of the fiber with the surface treatment agent, and optional surfactant and adhesion promoter, and the coating of the fiber with the polymer matrix resin may be accomplished in a single-step process to significantly improve productivity in process manufacturing of prepreg composite materials. The surface treatment agent, surfactant, adhesion promoter and polymer matrix resin may be included in a single dispersion slurry. The fiber/fabric may be treated with the dispersion slurry by using known manufacturing processes, such as dip coating the fabric into the slurry, drying and melting the surface treatment agent and polymer matrix onto the fabric to form a prepreg material. The melt temperature of the surface treatment agent and polymer matrix resin may be greater than the decomposition temperature of the surfactant used in the slurry. The surfactant preferably decomposes during the heating process to melt the polymers onto the fiber/fabric. It is preferred that the surface treatment agent, as well as the adhesion promoter and polymer matrix resin all have processing temperatures for drying and melting onto the fiber/fabric that are temperatures less than the degradation temperature of the fiber.

In a preferred embodiment, the fabric, including woven, unidirectional, non-woven or chopped fiber forms, is dipped into a nano-particle polymer dispersion of surface treatment agent and surfactant to wet the fiber/fabric and form the first layer of the prepreg. Upon dip coating the fabric, the surfactant in the dispersion helps to clean the fibers and displace residual machine and lubrication oil. The surface treatment agent in the dispersion solution intimately wets the surface of the fibers in the fabric. A second layer of thermoplastic polymer powder material is applied to the wet fibers. The powder has a median particle size of less than 30 micrometers in diameter. The powder is dispersed in an aqueous solution and applied as the second dip coating. The fiber/fabric with the two dispersion polymer coatings applied is dried to remove the water. The fiber/fabric with the two dispersion polymer coatings applied is heated to a process temperature at which the polymers soften and melt to form a film that adheres to the fibers and bond to the surface of the fibers in the fabric to produce the prepreg composite. The process temperature is sufficient to melt the polymers to adhere to the fibers in the fabric. The process temperature may be greater than the decomposition temperature of any residual surfactant in the coated fibers and the surfactant decomposes. The process temperature is less than the degradation temperature for the high tenacity fibers in the composition.

In another preferred embodiment, the fabric, including woven, unidirectional, non-woven or chopped fiber forms, is dipped into dispersion containing a nano-particle polymer dispersion of a surface treatment agent, a surfactant, and a micron-scale particle size slurry of a polymer matrix resin. On dip coating the fabric, the surfactant in the dispersion helps to clean the fibers and displace residual machine and lubrication oil. The nano-particle surface treatment agent in the dispersion solution intimately wets the surface of the fibers in the fabric. The thermoplastic powder slurry coats onto the fiber/fabric. The fiber/fabric with the two dispersion polymer coatings is dried to remove the water. The fiber/fabric with the two dispersion polymer coatings applied is heated to a process temperature at which the polymer particles soften and melt to form films that adhere to the fibers and bond to the surface of the fibers in the fabric to produce the prepreg composite. The process temperature is sufficient to melt the polymers to adhere to the fibers in the fabric. The process temperature may be greater than the decomposition temperature of any residual surfactant in the coated fibers and the surfactant decomposes. The process temperature is less than the degradation temperature for the high tenacity fibers in the composition.

Applicants specifically incorporate the entire content of all cited references in this disclosure. Further, when an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

### EXAMPLES

The following examples describe using polymer coatings to surface treat a high tenacity fiber so that the fiber is more strongly bound to the thermoplastic resin in forming a composite prepreg.

### Example 1

Example 1 describes making a prepreg by applying a polymer matrix resin to a high tenacity fiber without using a surface treatment agent. The high tenacity fiber/fabric is a glass fabric designated Style 7781 from Fiber-Glast Development Corporation. The glass fabric is an E-glass fabric in a plain weave construction that has an areal density of 9 ounces per square yard, and a thickness of 0.008″. The glass fabric does not have a surface treatment on the fibers. Polypropylene polymer resin pellets, from Atofina Petrochemicals, were cryogenically ground at a vendor to a mean particle diameter of 50 micrometers. The powder was coated onto the glass fabric and heated to 200° C. via exposure to a heat treatment process to a temperature above the melt temperature of the polypropylene powder. The powder melted onto the glass fiber fabric. The melted coating on the fabric was approximately 100 microns thick.

An adhesion test of the coated fabric surface was done according to ASTM D3359-07 Standard Test Method for measuring the adhesion by a tape test. The adhesion test demonstrated that the majority of the polypropylene resin melted onto the fabric peels off of the glass fabric sample. The glass fabric plus polypropylene coating failed the adhesion test.

### Example 2

Example 2 describes making a prepreg using a preferred embodiment. The glass fabric described in Example 1 was coated with a surface treatment agent. The surface treatment agent is Byk Cera Aquacer 593, a nano-particle dispersion of polypropylene in non-ionic surfactant and water, available from Byk Chemie Co. The polypropylene powder (50 micrometers diameter) polymer matrix resin from Example 1 was dispersed in the Aquacer 593 solution to make a slurry of 1 part nano-particle polypropylene to 2 parts 50 micrometer diameter polypropylene. This slurry was dip coated onto the glass fabric at a 80% volume resin coating on the fabric. The coated fabric was dried at 210° C. via exposure to a heat treatment process to melt the polypropylene surface treatment agent and polymer matrix resin onto the glass fibers of the fabric. At this temperature the residual surfactant decomposed forming a dark brown colored coating on the fabric.

An adhesion test of the coated fabric surface was done according to ASTM D3359-07 Standard Test Method for measuring the adhesion by a tape test. The adhesion test demonstrated strong adhesion of the coating onto the glass fiber with no adhesion failure.

### Example 3

Example 3 describes making a prepreg using a preferred embodiment. The fabric used as the high tenacity organic fiber is VECTRAN® HT, 1670 dtex, 600 filament, polyarylate fiber, commercially available from Kuraray America, Inc. VECTRAN® liquid crystal polyarylate fibers have a very low surface activity and must be treated with a surface treatment agent to optimize the intimate bonding of the polyarylate fiber surface to the thermoplastic matrix resin coating. A preferred surface treatment agent for coating the VECTRAN® HT fibers is PA-200 co-polyamide, which is commercially available from Sumitomo Chemical Company as a nano-particle aqueous dispersion containing surfactant.

Polyamide (PA11) polymer is a preferred polymer matrix resin in forming the prepreg. The polymer has high mechanical strength and exhibits good physical performance that is required for using the prepreg to manufacture composite parts applied in the transportation segment, especially automobile parts. PA11 has a melt temperature of 187° C. and can be combined with fiber reinforcement to produce composites with heat deflection values above 200° C. to avoid sagging in large horizonal surface part applications. PA11 resin density is 1.04 g/ml and combines with fiber reinforcement to provide a low specific mass composite to reduce body weight. The PA11 polymer backbone has reactive side chain groups that can bond with the surface treatment agent to get high wetting compatibility in forming the prepreg. Polyamides are known for their high chemical resistance. Polyamides are currently used in automobile production that can be recovered during recycling

A polyamide 11 (PA11) polymer powder, with mean diameter of less than 20 micrometers, is dispersed into the PA-200 co-polyamide aqueous dispersion and the combined dispersion slurry is applied to VECTRAN® HT fibers in a single dip coating. After application, the coated fibers are dried in a hot air oven at 90° C. to remove the water. The coated fabric is further heated to a processing temperature of >200° C. via exposure to a heat treatment process to melt the copolymer and PA11 powder polyamide onto the VECTRAN® HT fibers. The decomposition temperature of the residual surfactant in the prepreg is less than 200° C. and the surfactant decomposes forming a brown residue dispersed throughout the prepreg.

The coating formulation produces a dried prepreg that contains 10% by volume of the PA-200 copolyamide and 50% by volume of PA11. The resin concentration in the prepreg is sufficient to fully saturate the fabric during heat compression to produce a uniformly smooth surface finish on a composite part. PA11 has excellent melt flow properties and will flow onto the fabric fibers and saturate the fabric to form a fiber rich layer during thermoforming. PA11 has a low moisture regain value and will prevent the composite from absorbing moisture after thermoforming. PA11 also has high impact resistance at low temperatures and high chemical resistance, making it a good choice for automobile parts applications.

### Example 4

Example 4 describes making a prepreg using a preferred embodiment. The unidirectional fabric is made using T700 high tenacity carbon fiber from Toray Corporation. The unidirectional fabric has an areal density of 240 g/m² and was produced and supplied by Ichimura Corporation.

The surface treatment agent is Permarin UA-310, a thermoplastic polyether polyurethane nano-particle dispersion in N-methylpyrrolidone (NMP), available from Sanyo Chemical Co. The polymer matrix resin is RYTON® PPS, a polyphenylene sulfide powder with a particle size distribution of 60-200 microns, that is available from Chevron Phillips. The PPS powder was sieved to a powder that is less than 75 micrometers mean diameter. The PPS powder was dispersed into the UA-310 dispersion to make a smooth slurry and coated onto the carbon fabric. The material was dried to remove the NMP and then heated to 330° C. via exposure to a heat treatment process to melt the polymer coatings onto the fabric and to decompose the surfactant. The final resin coating on the prepreg was dark brown in color. The coating formulation produces a dried prepreg containing 5% by volume of the UA-310 and 50% by volume of the PPS. The resin concentration in the prepreg is sufficient to fully saturate the fabric during heat compression to produce a uniformly smooth surface finish on a composite part. The prepreg has a tensile modulus of 58 GPa and a tensile strength of 710 MPa tested using ISO 527-5B standard test procedure.

### Example 5

Example 5 describes making a prepreg using a preferred embodiment. The fabric used is a carbon fabric having a plain weave and areal density of 430 g/m² and woven by Ichimura Corporation using T300 high tenacity carbon fiber from Toray Corporation.

The surface treatment agent is VICOTE® 804, a polyetheretherketone (PEEK) nano-particle dispersion in an aqueous solution, available from Victrex Co. The polymer matrix resin is ULTEM® 1010P, a polyetherimide (PEI) powder with a mean particle size of 10 microns, available from GE Plastics. The PEI powder was blended into the VICOTE® dispersion to make a slurry for coating onto the carbon fabric. The material was dried to remove water and than heated to 350° C. via exposure to a heat treatment process to melt the polymer coatings onto the fabric and to decompose residual surfactant. The final resin coating on the prepreg was dark brown in color. The coating formulation produces a prepreg contain 10% by volume of the VICOTE® 804 and 50% by volume of the PEI. The resin concentration in the prepreg is sufficient to fully saturate the fabric during heat compression to produce a uniformly smooth surface finish on a composite part.

### Example 6

EXAMPLE 6 provides a listing of other examples of surface treatment agents used with compatible polymer matrix resins to make prepregs of the present invention. Table 1 includes a list of surface treatment agents that are in nano-particle polymer emulsion form that can be used to surface treat high tenacity fibers. The surface treatment agent compatibility is shown with various matrix resin polymers for making prepreg using this invention.

TABLE 1

| Surface-Treatment Agent | | Polymer Matrix Resin | | | | | | | | | | | | | |
|---|---|---|---|---|---|---|---|---|---|---|---|---|---|---|---|
| Chemical Name | Dispersion | PP | PE | PET | PA | TPU | PEMA | PMMA | PC | PS | PES | PPS | PEK* | PEI | TPI |
| Co-polyamide | PA-200 | | | PET | PA | TPU | PEMA | PMMA | PC | PS | PES | PPS | PEK* | | |
| Modified polyolefin | SB-1200 | PP | PE | PET | PA | | | | PC | | | | | | |
| Ethylene Glycidal Methacrylate | G-118 | PP | PP | PET | | | | | PC | PS | | | | | |
| Co-polymer | | | | | | | | | | | | | | | |
| Ionomer | S-100 | | | | PA | | | | | | | | | | |
| Polyetheretherketone | Vicote 804 | | | | | | | | | | | | PEK* | PEI | TPI |
| Polyether polyurethane | UA-310 | | | | | TPU | | | | | PES | PPS | | | |

NOTES:
Polypropylene (PP), Polyethylene (PE), Polyethylene Terephthalate (PET), Polyamide (PA), Thermoplastic polyurethane (TPU), Polyethylmethacrylate (PEMA), Polymethylmethacrylate (PMMA), Polycarbonate (PC),, polystyrene (PS), Polyethersulfone (PES), polyphenylene sulfide (PPS), Polyetherketone*: (Polyetherketone (PEK), Polyetherketoneketone (PEKK), (Polyetheretherketone (PEEK)), Polyetherimide (PEI), Thermoplastic Polyimide (TPI)

PA-200 co-polyamide is a nano-particle aqueous dispersion that is commercially available from Sumitomo Chemical Co. SB-1200 is a modified polyolefin in a nano-particle aqueous dispersion that is commercially available from Unitika Ltd. G-118 ethylene glycidal methacrylate co-polymer is a nano-particle aqueous dispersion that is commercially available from Sumitomo Chemical Co. S-100 Ionomer is a nano-particle aqueous dispersion that is commercially available from Mitsui Chemical Co. VICOTE® 804 PEEK emulsion is a nano-particle aqueous dispersion available from Victrex Co. UA-310 thermoplastic polyether polyurethane is a nano-particle dispersion in NMP and is available from Sanyo Chemical Co.

1. A prepreg composite comprising:
a) a high tenacity fiber;
b) a surface treatment agent, wherein the surface treatment agent is coated on the surface of the fiber; and
c) a polymer matrix resin, wherein the polymer matrix resin is coated on the surface of the fiber.

2. The prepreg composite of claim 1, wherein the coating of b) is melted on the surface of the fiber as a result of exposure to a heat treatment process above the melt temperature of the surface treatment agent.

3. The prepreg composite of claim 1, wherein the coating of c) is melted on the surface of the fiber as a result of exposure to a heat treatment process above the melt temperature of the polymer matrix resin.

4. The prepreg composite of claim 1, wherein the coatings of b) and c) are melted on the surface of the fiber as a result of exposure to a heat treatment process above the melt temperature of the surface treatment agent and above the melt temperature of the polymer matrix resin.

5. The prepreg composite of claim 4, wherein the heat treatment process temperature is below the degradation temperature of the fiber.

6. The prepreg composite of claim 1, wherein the prepreg composition is substantially free of surfactant as a result of exposure to a heat treatment process above the decomposition temperature of the surfactant.

7. The prepreg composite of claim 1, wherein the high tenacity fiber comprises a compound selected from the group consisting of polyarylate, poly-p-benzamide, poly-paraphenylene terephthalamide, poly-(p-phenylene-2,6-benzobisoxazole), meta-linked aromatic polyamide, carbon, glass and silicone carbide.

8. The prepreg composite of claim 1, wherein the surface treatment agent comprises one or more compounds selected from the group consisting of polyamide/epoxidized styrene-butadiene block copolymer, ethylene glycidyl methacrylate copolymer, co-polypropylene, co-polyester, epoxy, polymethacrylate iso-butylester, polymethacrylic n-butylester, butyl methacrylate-styrene, copolymer, polymethylmethacrylate, polyamide, co-polyamide, polyvinyl acetate, polyvinyl alcohol, polyethylene, polyurethane, thermoplastic polyether polyurethane, polyester, silyl resins, silyl-dimethacrylate, siloxane bond resins and silane coupling agents.

9. The prepreg composite of claim 1, wherein the mean particle size of the surface treatment agent is less than about 1 micrometers.

10. The prepreg composite of claim 1, wherein the polymer matrix resin comprises a compound selected from the group consisting of thermoplastic polymers including of polyethylene, polypropylene, polyethylene terephthalate, polyamide, polyurethane, polyethylmethacrylate, polymethylmethacrylate, polycarbonate, polystyrene, polyetherketone (PEK, PEKK, PEEK), polyether sulfone, polyphenylene sulfide, polyester amide, polystyrene, polyetherimide and polyimide.

11. The prepreg composite of claim 1, wherein the mean particle size of the polymer matrix resin is less than about 200 micrometers.

12. The prepreg composite of claim 1, further comprising a surfactant, wherein the surfactant is coated on the surface of the fiber.

13. The prepreg composite of claim 1, further comprising an adhesion promoter, wherein the adhesion promoter is coated on the surface of the fiber.

14. A dispersion containing a surface treatment agent and a polymer matrix resin.

15. The dispersion of claim 14, wherein the surface treatment agent comprises one or more compounds selected from the group consisting of polyamide/epoxidized styrene-butadiene block copolymer, ethylene glycidyl methacrylate copolymer, co-polypropylene, co-polyester, epoxy, polymethacrylate iso-butylester, polymethacrylic n-butylester, butyl methacrylate-styrene, copolymer, polymethylmethacrylate, polyamide, co-polyamide, polyvinyl acetate, polyvinyl alcohol, polyethylene, polyurethane, thermoplastic polyether polyurethane, polyester, silyl resins, silyl-dimethacrylate, siloxane bond resins and silane coupling agents.

16. The dispersion of claim 14, wherein the mean particle size of the surface treatment agent is less than about 1 micrometers.

17. The dispersion of claim 14, wherein the polymer matrix resin comprises a compound selected from the group of thermoplastic polymers consisting of polyethylene, polypropylene, polyethylene terephthalate, polyamide, polyurethane, polyethylmethacrylate, polymethylmethacrylate, polycarbonate, polystyrene, polyetherketone (PEK, PEKK, PEEK), polyether sulfone, polyphenylene sulfide, polyester amide, polystyrene, polyetherimide or polyimide.

18. The dispersion of claim 14, wherein the mean particle size of the polymer matrix resin is less than about 200 micrometers.

19. The dispersion of claim 14, further comprising a surfactant.

20. The dispersion of claim 14, further comprising an adhesion promoter.

21. A method of manufacture of a prepreg composite comprising:
a) coating a high tenacity fiber with a surface treatment agent;
b) simultaneously coating the fiber with a thermoplastic polymer matrix resin; and
c) heating the fiber comprising a surface treatment agent coating and thermoplastic polymer matrix resin coating to a temperature above the melt temperature of the surface treatment agent;
wherein the coating steps of a) and b) comprise dipping the fiber into a dispersion containing nano-particles of the surface treatment agent and micro-scale particles of the thermoplastic polymer matrix resin;
the mean particle size of the surface treatment agent is less than about 1 micrometers; and
the mean particle size of the thermoplastic polymer matrix resin is less than about 200 micrometers; and
wherein the ratio of the surface treatment agent is about 1 to about 20% of the prepreg, and the ratio of the thermoplastic polymer matrix resin is greater than about 20% of the prepreg.

22. (canceled)

23. (canceled)

24. (canceled)

25. (canceled)

26. The method of claim 21, further comprising a step of heating the fiber comprising a surface treatment agent coating and thermoplastic polymer matrix resin coating to a temperature above the boiling point of any liquid form material on the fiber.

27. (canceled)

28. The method of claim 21, further comprising a step of heating the fiber comprising a surface treatment agent coating and thermoplastic polymer matrix resin coating to a temperature above the melt temperature of the thermoplastic polymer matrix resin.

29. (canceled)

30. The method of claim 21, wherein the temperature the fiber is heated to is below the degradation temperature of the fiber.

31. The method of claim 21, further comprising a step of heating the fiber to a temperature above the decomposition temperature of any residual surfactant in the coatings.

32. The method of claim 21, wherein the high tenacity fiber comprises a compound selected from the group consisting of polyarylate, poly-p-benzamide, poly-praraphenylene terephthalamide, poly-(p-phenylene-2,6-benzobisoxazole), meta-linked aromatic polyamide, carbon, glass and silicone carbide.

33. The method of claim 21, wherein the high tenacity fiber comprises a compound selected from the group consisting of glass, polyarylate and carbon.

34. The method of claim 21, wherein the surface treatment agent comprises one or more compounds selected from the group consisting of polyamide/epoxidized styrene-butadiene block copolymer, ethylene glycidyl methacrylate copolymer, co-polypropylene, co-polyester, epoxy, polymethacrylate iso-butylester, polymethacrylic n-butylester, butyl methacrylate-styrene, copolymer, polymethylmethacrylate, polyamide, co-polyamide, polyvinyl acetate, polyvinyl alcohol, polyethylene, polyurethane, thermoplastic polyether polyurethane, polyester, silyl resins, silyl-dimethacrylate, siloxane bond resins and silane coupling agents.

35. The method of claim 21, wherein the surface treatment agent comprises a compound selected from the group consisting of polypropylene, co-polyamide, polyether polyurethane, polyetheretherketone, ionomer, modified polyolefin, and ethylene glycidal methacrylate co-polymer.

36. The method of claim 21, wherein the thermoplastic polymer matrix resin comprises a compound selected from the group consisting of polyethylene, polypropylene, polyethylene terephthalate, polyamide, polyurethane, polyethylmethacrylate, polymethylmethacrylate, polycarbonate, polystyrene, polyetherketone (PEK, PEKK, PEEK), polyether sulfone, polyphenylene sulfide, polyester amide, polystyrene, polyetherimide and polyimide.

37. The method of claim 21, wherein the thermoplastic polymer matrix resin comprises a compound selected from the group consisting of polyethylene, polypropylene, polyethylene terephthalate, polyamide, polyurethane, polyethylmethacrylate, polymethylmethacrylate, polycarbonate, polystyrene, polyetherketone (PEK, PEKK, PEEK), polyether sulfone, polyphenylene sulfide, polyetherimide and polyimide.

38. The method of claim 21, wherein the dispersion further comprises a surfactant.

39. The method of claim 21, wherein the dispersion further comprises an adhesion promoter.
